(19) United States
(12) Patent Application Publication
(10) Pub. No.: US 2003/0046583 A1
(43) Pub. Date: Mar. 6, 2003

(54) Automated configuration of security software suites

(75) Inventors: Robert P. Goldman, Minneapolis, MN (US); Steven A. Harp, Coon Rapids, MN (US); Vicraj T. Thomas, Golden Valley, MN (US)

Correspondence Address: Honeywell International Inc., Law Dept. AB2, P.O. Box 2245, Morristown, NJ, 07962-9806, US

(73) Assignee: Honeywell International Inc.

(21) Appl. No.: 09/943,405

(22) Filed: Aug. 30, 2001

(51) Int. Cl. H04L 9/00

(52) U.S. Cl. 713/201

(57) ABSTRACT

Network reference models and configuration tools utilizing a database engine providing deduction facilitate automatic or semi-automatic configuration of security software packages based on security policies. One or more associated databases provide a central repository of information about the network and its security goals. The associated databases may further provide a central repository of information about network events, such as possible attacks and benign events that could be confused with attacks. Taken together, the database engine and associated databases facilitate automated generation of detailed security goals. The security goals can then be used by various configuration modules to configure security software packages installed within the network.

### STATEMENT OF GOVERNMENT INTEREST

This invention was made with U.S. Government support under Contract F30602-99-C-0177 awarded by the U.S. Air Force. The U.S. Government has certain rights in this invention.

### FIELD OF THE INVENTION

The present invention relates generally to software configuration, and in particular to the automated configuration of security software suites using a deductive database of network structure and security goals.

### BACKGROUND OF THE INVENTION

There are a variety of intrusion detection systems, firewalls and other security software packages designed to detect or block unauthorized use of a computer system. Such security software packages are able to detect or block various classes of intrusions into individual hosts and computer networks. As used herein, the term “software” subsumes “firmware.” Firmware is software that is stored in non-volatile memory, such as flash memory or other programmable read-only memory (PROM).

Individual security software packages each will have at least one blind spot or other vulnerability dependent upon the approach each utilizes in detecting, suspecting or blocking intrusion. System administrators thus generally need to have multiple security software packages installed on a host or network such that at least one security software package protects the blind spot of other security software packages.

It is generally very difficult to configure and install these security software packages to work properly in concert or as a suite. Security software packages generally need to know system configuration information to function properly. While this can be easy to provide in a static network, it becomes increasingly difficult in a dynamically changing environment where old systems may be removed, new systems may be added and existing systems may be modified. In addition, the security software packages must be configured in a way that does not cripple the purpose or goal of the computer network. For example, the security software packages cannot simply block all incoming packets if the computer network is designed to support electronic commerce interactions. Such difficulties are compounded by the fact that each security software package generally has its own configuration files and tags.

For the reasons stated above, and for other reasons stated below that will become apparent to those skilled in the art upon reading and understanding the present specification, there is a need in the art for alternative methods configuring suites of security software packages.

### SUMMARY

Network reference models and configuration tools are described utilizing a database engine providing deduction to facilitate automatic or semi-automatic configuration of security software packages based on security policies. The database engine is preferably an object-oriented description logic database engine. One or more associated databases provide a central repository of information about the network and its security goals. The associated databases may further provide a central repository of information about network events, such as possible attacks and benign events that could be confused with attacks. Taken together, the database engine and associated databases facilitate automated generation of detailed security goals. The security goals can then be used by various configuration modules to configure security software packages installed within the network.

For one embodiment, the invention provides a network reference model for use in configuring security software on a computer network. The network reference model includes a database engine providing deduction, a network information database associated with the database engine and a security goal database associated with the database engine. The network information database provides a central repository for a configuration of hardware and software installed on the network. The security goal database describes uses that the hardware and software installed on the network may support.

For another embodiment, the invention provides a configuration tool for use in configuring security software packages on a computer network. The configuration tool includes a description logic database engine, a network information database associated with the description logic database engine, a security goal database associated with the description logic database engine, a first configuration module coupled to the description logic database engine for configuring intrusion blocking security software packages, and a second configuration module coupled to the description logic database engine for configuring intrusion detecting security software packages. The network information database provides a central repository for a configuration of hardware and software installed on the network while the security goal database provides security goals describing uses that the hardware and software of the network may support. The first configuration module configures the intrusion blocking security software packages based on the configuration of the hardware and software installed on the network and the security goals while the second configuration module configures the intrusion detecting security software packages based on the configuration of the hardware and software installed on the network and the security goals.

For yet another embodiment, the invention provides a method for configuring a security software package installed on an individual network device. The method includes using active inference in a database engine to decompose one or more security policies for a class of network devices into one or more security goals for the individual network device. The individual network device is a member of the class of network devices. The method further includes configuring the security software package using the one or more security goals.

For still another embodiment, the invention provides a method for configuring security software packages. The method includes generating a first database containing a configuration of hardware devices and software packages installed on a network, wherein the software packages include the security software packages. The method further includes defining classes of hardware devices installed on the network and automatically classifying each of the hardware devices into one of the classes of hardware devices using a database engine providing deduction. The method still further includes generating a second database containing first security goals and decomposing the first security goals into second security goals for individual hardware devices using the database engine and the configuration of the hardware devices and the software packages installed on the network. The method still further includes configuring each of the security software packages using the second security goals.

Further embodiments of the invention include methods and apparatus of varying scope.

### BRIEF DESCRIPTION OF THE DRAWINGS

FIG. 1 is a block diagram of a configuration tool in accordance with an embodiment of the invention.

FIG. 2 is a schematic of a network in accordance with an embodiment of the invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

Network configuration tools of the various embodiments utilize a database engine providing deduction to facilitate automated configuration of security software packages based on security policies, such as those set by a system administrator. The database engine is preferably an object-oriented description logic database engine. One or more associated databases provide a central repository of information about the network and its security goals. The associated databases may further provide a central repository of information about network events, such as possible attacks and benign events that could be confused with attacks. Taken together, the database engine and associated databases facilitate automated generation of detailed security goals. The security goals can then be used by various configuration modules to configure security software packages installed within the network.

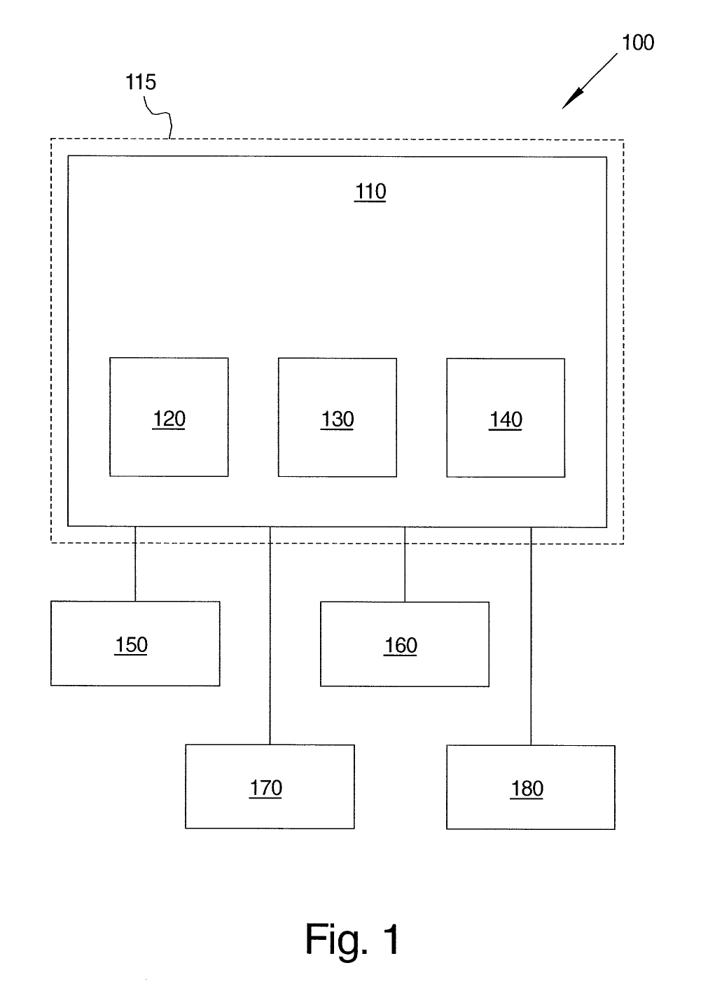

FIG. 1 is a schematic of a configuration tool 100 in accordance with an embodiment of the invention. The configuration tool 100 includes a database engine 110. The database engine 110 is a database engine providing deduction, preferably a description logic database engine. Other example database engines include deductive database engines and forward chaining systems. Such database engines provide active inference, such as automatic classification of classes and/or objects into a generalization hierarchy, rule firing and maintenance, inheritance, propagation and bounds constraints. Such database engines further facilitate handling of incomplete and incrementally evolving knowledge bases. For one embodiment, the database engine 110 is an object-oriented, description logic database engine. For a further embodiment, the database engine 110 is the CLASSIC object-centered knowledge representation and reasoning tool available from Lucent Technologies Inc., Murray Hill, N.J., USA. The semantics of description logic systems like CLASSIC is typically expressed in terms of first order logic. Description logic systems provide a way to more efficiently draw a subset of the conclusions that could be drawn using the full power of first-order logic. See, e.g., A. Borgida and P. F. Patel-Schneider, “A Semantics and Complete Algorithm for Subsumption in the CLASSIC Description Logic,” Journal of Artificial Intelligence Research, 1, 1994, pp. 277-308. Description logic systems can be understood and practiced using normal logic. See, e.g., P. J. Hayes, “The Logic of Frames,” in Frame Conceptions and Text Understanding, D. Metzing, ed., Berlin: Walter de Gruyter and Co., 1979, reprinted in Readings in Knowledge Representation, R. J. Brachman and J. Levesque, eds., Morgan Kaufman, 1985. Description logic systems may also be referred to as frame-based systems, knowledge representation languages, or KL-ONE style languages.

An object-oriented description logic database engine 110 is able to automatically classify objects and, based on their classification, apply rules to those objects. Using this approach, the database engine 110 is able to infer security goals to conform to a given security policy.

The database engine 110 is associated with three databases 120, 130 and 140. While these databases are depicted as distinct entities in FIG. 1, there is no requirement that the data structures be logically separated.

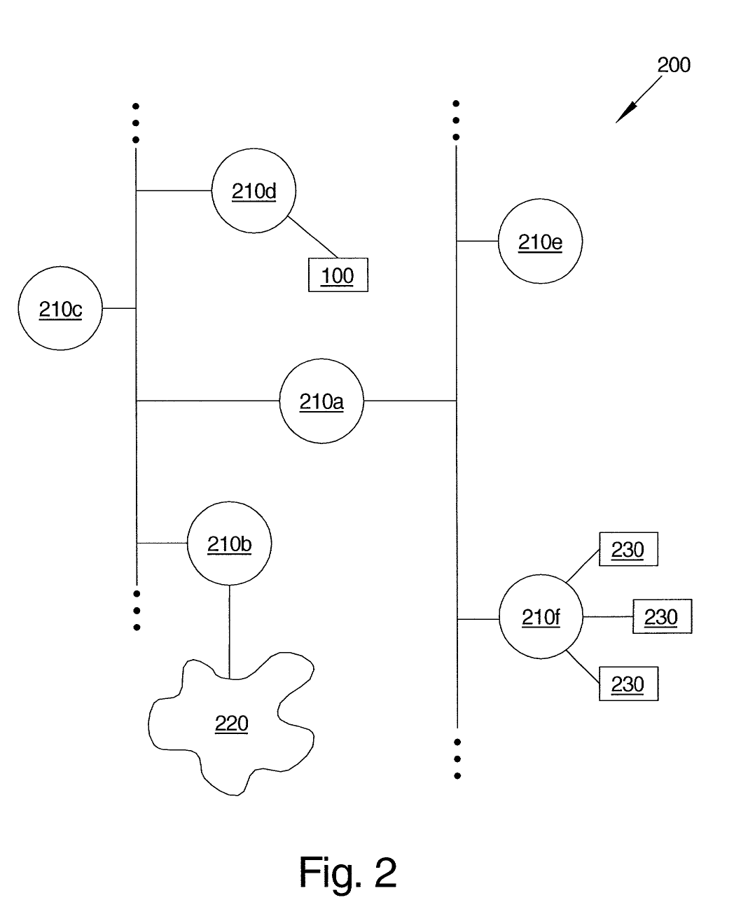

The first database is a network information database 120. The network information database 120 contains information about the network (see discussion regarding FIG. 2) that is needed for configuration of the security software packages residing on hosts or other devices of the network. The network information database 120 provides a central repository for the configuration of hardware and software installed on a network. As such, the network information database 120 contains information, for example, about the hosts on the network, key services offered by the network hosts and the network topology. A network information database may also be referred to as a network entity/relationship database.

The central concepts, or classes, of the network information database 120 include those of network, host, operating system and service. The hosts run operating systems and operating systems run services. Services are a concept that subsumes both local services, i.e., those provided to users of the machine itself, and network services, i.e., those provided to remote users.

For one embodiment, the network information database 120 is populated manually. However, it is preferred that the network information database 120 is populated automatically, such as by using a network discovery tool to periodically search the network for connected devices and their offered services.

The second database is a security goal database 130. The security goal database 130 describes the uses that the equipment (hardware and software) of the network are intended to support.

The security goal database 130 may contain definitions of categories of network entities. For example, a first category may be defined as DMZ (demilitarized zone) hosts referring to hosts that are part of the DMZ subnetwork and which are intended to provide services to users from outside the network. A second category may be defined as DNS (domain naming system) hosts referring to hosts that provide DNS services. Other categories may further be defined. The relationship of a host within a network is generally reasoned based on its IP configuration(s), the network topology and the services it provides.

The security goal database 130 further contains definitions of security goals. For example, a security goal may specify that DNS hosts that are not in the DMZ should not provide zone transfers to hosts outside the network, that SMTP (Simple Mail Transfer Protocol) mail serving hosts should not accept connections from hosts outside the network, that no user is to be permitted to have a “.rhosts” file, that e-commerce hosts should provide order entry service to authorized users, that an internal database host should provide access to the database to authorized users of internal (only) hosts, that a web server should provide access to public information to anyone, etc. The security goal database 130 contains specifications of the types of events that will compromise a network device.

The security goal database 130 further contains a decomposition of high-level security goals into low-level security goals. For example, a high-level goal may be for network nondisclosure, i.e., keeping details of the internal network hidden from outsiders. Such a goal would decompose into sub-goals of network nondisclosure for each of the subsidiary networks, with the exception of the DMZ. In turn, this may decompose to more specific goals such as the prohibition against DNS zone transfers. A prohibition against unregulated use of the Berkeley R-Login services would lead to a restriction against “.rhost” files.

For one embodiment, the security goal database 130 facilitates a higher order security policy, or security meta-policy, extending beyond security policies traditionally associated with configuration tools. Traditional security policies may, for example, prohibit or prescribe activities associated with a particular host. In contrast, a security meta-policy relieves the system administrator of associating security policies with individual hosts. The security meta-policy can associate security policies with higher-level groupings, e.g., by functionality or by class of hosts. Decomposition and inference is used to associate lower-level goals with individual hosts.

The third database is the optional event database 140. The event database 140 contains events related to the network to be managed. These events include possible attacks against the network as well and benign events that could be confused with such attacks. Such information can be used in conjunction with probe systems designed to check for vulnerabilities.

The database engine 110 and its associated databases make up a network reference model 115. The network reference model 115 facilitates automatic generation of full security goals within the network. A security meta-policy in the security goal database 130 will use information about network structure in the network information database 120 to generate detailed security goals for individual nodes of the network. Such decomposition of the security meta-policy is facilitated by the deductive capabilities of the database engine 110.

Using the example of network nondisclosure as the security meta-policy, the network reference model 115 would decompose the security meta-policy to lower level security goals, such as prohibiting zone transfers to hosts outside the network for any host providing DNS services that is not in the DMZ. The network reference model 115 would further identify all hosts providing DNS services. This list of hosts providing DNS services could also be checked against a list of hosts intended to provide DNS services. Any disagreement could be flagged for action by a system administrator or used to disable or shut down the apparently unauthorized service. Upon identification of those DNS hosts not in the DMZ, the network reference model 115 could associate the security goal with each identified host.

One or more configuration modules can use the information contained and generated by the network reference model 115 to automatically configure security software packages. As shown in FIG. 1, one such configuration module may be a configuration module 150 for configuring intrusion blocking security software packages. Such security software packages may include or be associated with firewalls, routers, switches, etc. The configuration module 150 may include one or more vendor-specific configuration scripts to configure specific security software packages and/or one or more vendor-independent configuration modules. An example of a vendor-independent configuration module is the Firmato firewall management toolkit described by Y. Bartal et al., “Firmato: A Novel Firewall Management Toolkit,” as presented at The IEEE (Institute of Electrical and Electronics Engineers, Inc.) Symposium on Security and Privacy, May 9-12, 1999, Oakland, Calif., USA.

The intrusion blocking configuration module 150 uses information about the network topology and the services which are desired to be provided (or prohibited) to users inside and outside of the network. Using the security goals generated by the network reference model 115, the intrusion blocking configuration module 150 configures how network transmissions are to be permitted to occur, or to be prohibited from occurring. This leads to a more automated, and likely more consistent, configuration of the software packages than has been possible with prior configuration tools. In a typical application of Firmato, for example, a user would be required to develop specific security goals for a given network topology to configure the various firewall packages installed on that topology. As used herein, the specific security goals are generated by the network reference model 115 as described above to facilitate a more automated configuration of firewall packages.

As shown in FIG. 1, a second configuration module may include a configuration module 160 for configuring intrusion detecting security software packages commonly known as intrusion detection systems (IDS). Examples of an IDS include a host-based file system integrity checking software package, such as Tripwire (available from Tripwire, Inc., Portland, Oreg., USA), a host-based event-log watching software package, such as the EMERALD Expert BSM (available from SRI International, Menlo Park, Calif., USA), or a network-based software package, such as Snort, an open-source network IDS (NIDS). The IDS configuration module 160 may include one or more vendor-specific configuration scripts to configure specific IDS packages and/or one or more vendor-independent configuration modules.

Additional modules can be used in conjunction with the network reference model 115 in accordance with various embodiments of the invention. One such module is a system hardening module 170. The system hardening module 170 includes one or more software packages to automate the process of “hardening” a network. One example software package includes the open-source Bastille Hardening System developed by the Bastille Linux Project and available through a variety of sources, including the SourceForge Collaborative Development System of VA Linux Systems, Inc., Fremont, Calif., USA. The Bastille Hardening System attempts to “harden” or “tighten” the Linux operating system. As an example of its operation, the Bastille Hardening System will query a user to suggest that they disable (or possibly remove) the sendmail service, which is the source of many security problems, but which is necessary for mail servers. It is sometimes unclear how the configuration options will impact function of the hosts to which they are applied and hence, how they will affect the ability of the network to perform its mission. With information from the network reference model 115, the system hardener could become context-sensitive, modifying its dialogues in a manner appropriate to the network topology and security policies.

Another module that can be used in conjunction with the network reference model 115 in accordance with various embodiments of the invention includes an audit configuration module 180. The audit configuration module 180 includes one or more software packages to probe a network for vulnerabilities. Some example software packages include the open source packages of SATAN (Security Administrator Tool for Analyzing Networks), SAINT (Security Administrator's Integrated Network Tool) and the Nessus Security Scanner. The information and capabilities of the network reference model 115 can be used to focus such probes and to determine the import of the existence of certain vulnerabilities. As an example, certain servers behind a double-layered firewall (firewall-DMZ-firewall) would be permitted to be more vulnerable than servers within the DMZ.

Configuration tools and network reference models in accordance with the invention are adapted for use with a network of computers and related devices. FIG. 2 is a schematic of one example of a network 200 for use with the invention. The network 200 includes a variety of interconnected network devices 210. The network devices 210 may include a number of hosts, such as hosts 210c, 210d, 210e and 210f. The network devices 210 may further include a router 210b for communications between the network 200 and an external network such as the Internet 220.

The network 200 may include two or more subnetworks, such as a first subnetwork including router 210b and hosts 210c and 210d, and a second subnetwork including hosts 210e and 210f. The subnetworks are generally coupled to a gateway, such as gateway 210a, for communications between the subnetworks. Each host may be associated with one or more users 230. At least one host should provide the configuration tool 100 as a service, such as host 210d. Security software associated with the various network devices 210 may be configured using the configuration tool 100 as described with reference to FIG. 1. It is noted that the network 200 described with reference to FIG. 2 is but one example of a network configuration. Such networks can be configured in an almost endless variety of configurations.

### CONCLUSION

Network reference models and configuration tools have been described utilizing a database engine providing deduction to facilitate automatic or semi-automatic configuration of security software packages based on security policies. The database engine is preferably an object-oriented description logic database engine. One or more associated databases provide a central repository of information about the network and its security goals. The associated databases may further provide a central repository of information about network events, such as possible attacks and benign events that could be confused with attacks. Taken together, the database engine and associated databases facilitate automated generation of detailed security goals. The security goals can then be used by various configuration modules to configure security software packages installed within the network.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

What is claimed is:

1. A network reference model for use in configuring security software on a computer network, the network reference model comprising:
a database engine providing deduction;
a network information database associated with the database engine and providing a central repository for a configuration of hardware and software installed on the network; and
a security goal database associated with the database engine and describing uses that the hardware and software installed on the network may support.

2. The network reference model of claim 1, further comprising:
an event database associated with the database engine and containing events related to the network, wherein such events include possible attacks against the network and benign events that could be confused with the possible attacks.

3. The network reference model of claim 1, wherein the database engine is an object-oriented description logic database engine.

4. A configuration tool for use in configuring security software packages on a computer network, the configuration tool comprising:
a description logic database engine;
a network information database associated with the description logic database engine and providing a central repository for a configuration of hardware and software installed on the network;
a security goal database associated with the description logic database engine and providing security goals describing uses that the hardware and software of the network may support;
a first configuration module coupled to the description logic database engine for configuring intrusion blocking security software packages; and
a second configuration module coupled to the description logic database engine for configuring intrusion detecting security software packages;
wherein the first configuration module configures the intrusion blocking security software packages based on the configuration of the hardware and software installed on the network and the security goals; and
wherein the second configuration module configures the intrusion detecting security software packages based on the configuration of the hardware and software installed on the network and the security goals.

5. The configuration tool of claim 4, further comprising:
an event database associated with the description logic database engine and containing events related to the network.

6. The configuration tool of claim 5, wherein the events contained in the event database include possible attacks against the network and benign events that could be confused with the possible attacks.

7. The configuration tool of claim 4, further comprising:
a system hardening module coupled to the description logic database engine for automating a process of hardening the network.

8. The configuration tool of claim 7, wherein the system hardening module is context sensitive.

9. The configuration tool of claim 4, further comprising:
an audit configuration module coupled to the description logic database engine for probing the network for vulnerabilities.

10. A configuration tool for use in configuring security software packages on a computer network, the configuration tool comprising:
a description logic database engine;
a network information database associated with the description logic database engine and providing a central repository for a configuration of hardware and software installed on the network;
a security goal database associated with the description logic database engine and providing security goals describing uses that the hardware and software of the network may support;
an event database associated with the description logic database engine and containing events related to the network, wherein the events contained in the event database include possible attacks against the network and benign events that could be confused with the possible attacks;
a first configuration module coupled to the description logic database engine for configuring intrusion blocking security software packages;
a second configuration module coupled to the description logic database engine for configuring intrusion detecting security software packages;
a system hardening module coupled to the description logic database engine for automating a process of hardening the network; and
an audit configuration module coupled to the description logic database engine for probing the network for vulnerabilities;
wherein the first configuration module configures the intrusion blocking security software packages based on the configuration of the hardware and software installed on the network and the security goals;
wherein the second configuration module configures the intrusion detecting security software packages based on the configuration of the hardware and software installed on the network and the security goals; and
wherein the system hardening module is context sensitive.

11. A method for configuring a security software package installed on an individual network device, the method comprising:
using active inference in a database engine to decompose one or more security policies for a class of network devices into one or more security goals for the individual network device, wherein the individual network device is a member of the class of network devices; and
configuring the security software package using the one or more security goals.

12. The method of claim 11, wherein using active inference further comprises automatically classifying the individual network device based on an IP address, a network topology or a service provided by the individual network device, and applying rules to the individual network device based on its classification.

13. The method of claim 11, wherein the database engine is an object-oriented description logic database engine.

14. The method of claim 11, wherein the security software package is selected from the group consisting of an intrusion blocking software package and an intrusion detecting software package.

15. A method for configuring a security software package installed on an individual network device, the method comprising:
using active inference in an object-oriented description logic database engine to decompose one or more security policies for a class of network devices into one or more security goals for the individual network device, wherein the individual network device is a member of the class of network devices; and
configuring the security software package using the one or more security goals;
wherein the security software package is selected from the group consisting of an intrusion blocking software package and an intrusion detecting software package.

16. The method of claim 15, wherein using active inference further comprises automatically classifying the individual network device based on an IP address, a network topology and one or more services the individual network device provides, and applying rules to the individual network device based on its classification.

17. A method for configuring a security software package, the method comprising:
defining one or more security policies for a class of network devices, wherein the security software package is a service running on at least one network device of the class of network devices;
using a database engine providing deduction to decompose the one or more security policies for the class of network devices into one or more security goals;
using to database engine providing deduction to associate the one or more security goals with the at least one network device; and
configuring the security software package on the at least one network device using the one or more security goals.

18. A method for configuring security software packages, comprising:
generating a first database containing a configuration of hardware devices and software packages installed on a network, wherein the software packages include the security software packages;
defining classes of hardware devices installed on the network;
automatically classifying each of the hardware devices into one of the classes of hardware devices using a database engine providing deduction;
generating a second database containing first security goals;
decomposing the first security goals into second security goals for individual hardware devices using the database engine and the configuration of the hardware devices and the software packages installed on the network; and
configuring each of the security software packages using the second security goals.

19. The method of claim 18, wherein generating a second database containing first security goals further comprises generating a second database containing first security goals for each class of hardware devices.

20. The method of claim 19, wherein decomposing the first security goals into second security goals for individual hardware devices further comprises using inference to associate the second security goals with individual hardware devices within each class of hardware devices.
